(19) United States
(12) Patent Application Publication
(10) Pub. No.: US 2011/0191188 A1
(43) Pub. Date: Aug. 4, 2011

(54) METHOD AND A SYSTEM FOR DISSEMINATING DIGITAL DATA

(76) Inventors: Jean Canzoneri, Paris (FR); Jean-Christophe De Launay, Paris (FR); Thomas Pasquet, Levallois Perret (FR)

(21) Appl. No.: 13/054,935

(22) PCT Filed: Feb. 16, 2010
(86) PCT No.: PCT/IB10/00287

§ 371 Date: Apr. 18, 2011

(30) Foreign Application Priority Data
Feb. 16, 2009 (US) 61/152784

(51) Int. Cl. G06Q 30/00

(52) U.S. Cl. 705/14.66; 705/14.4

(57) ABSTRACT

The invention relates to a method and a system for the dissemination of digital data between a terminal and a digital data dissemination platform including the following steps: connection of the terminal to a server of the platform, —authentication of a user to his account by the transmission of an identifier to the server, —selection from means of selection of the terminal by user of: •the digital data to be downloaded, and • a video spot that the user wishes to see during the downloading of the digital data, display of the video spot on the screen of the terminal, wherein the downloaded digital data is validated, in order to be useable, by the user by actuating the means of selection during a time t of a countdown which is displayed on the screen at the end of the broadcasting of the video spot.

### FIELD OF THE INVENTION

The invention relates to a method for disseminating digital data and a system for implementing this method.

More particularly, the invention relates to the field of the dissemination of digital data such as audio and/or video files associated with spots corresponding to graphic images or audio and/or video data.

### BACKGROUND OF THE INVENTION

The music online downloading market can be broken down into two big types of offers:
the legal and paying online music platforms, and
the illegal and free platforms. These currently represent the greatest part of music downloading on the internet.

A challenge thus consists in convincing the Internet mobile users which illegally download to comply with legal practices.

Therefor, two pre-requisites are necessary to convince them:
the free downloading, which supposes that other sources of financing are identified for this type of offers.
an incentive, beyond the argument of legality, to convince them to change their behavior.

Considering the purchase price of music with record companies, conventional advertisement models based on simple banners, prominent advertisement or commercial videos imposed in small format and without any guaranteed viewing, cannot today enable the economical continuity of the platforms based on these models.

Thus, a problem arises as to allow the free and legal downloading of audio and/or video data from an economically independent data dissemination system.

In the prior art, video data distribution methods are known, which do not make it possible to obtain freely and legally a music title in a perennial economical scheme for the platform which puts this title at the user's disposal for downloading.

Such methods do not participate in containing the development of offers for free illegal downloading, and are responsible for the absence of offers for legal and free downloading, because there is no model capable of guaranteeing the economic feasibility of such an offer.

To remedy this drawback, the invention provides, in a perennial economical scheme, a legal and free downloading platform for the downloading of music titles. It reaches this goal by combining a set of principles, among which:
the utilization of a 30 days WMA DRM time out, which means a 30 days' renewable license, which makes it possible to reduce the purchase price of titles and to guarantee the regular visit of the Internet mobile user to the platform;
the implementation of video advertising device with an improved efficiency;
the automatic implementation of an advertisement on the sleeve of the downloaded title, and
the implementation of a loyalty point system rewarding the Internet mobile user upon each downloading which can be converted into coupons with the partner e-commerce sites which give a compensation to the owners of the invention.

Thus, the combination of these various characteristics interacting together makes it possible to create the capacity of financing a title which has been freely and legally downloaded.

In addition, the advertisement distribution mechanisms in the audio and/or video data dissemination method of the prior art have different drawbacks such as:
the limitation of their selling price;
the spot is imposed to the Internet mobile user who does not select the one he/she wants to see;
the spot is broadcast in a small format generally ⅕ of the screen size, even though it can be enlarged to the full screen, if the Internet mobile user wishes to;
no system is provided to make sure that the person receiving the audio and/or video data (for example the Internet mobile user) is not busy doing something else on his or her computer while the spot is broadcast, and
no system is provided to make sure that the person receiving the audio and/or video data (for example the Internet mobile user) is in front of his or her computer during the broadcasting of the spot (he or she can launch the broadcasting and leave the room and no longer be in front of the screen).

These drawbacks are solved by the invention since:
the broadcast spot which is viewed or listened to by the person receiving the audio and/or video data (for example the Internet mobile user) is freely selected by the Internet mobile user during the downloading of the audio and/or video data or prior to launching the downloading, among a selection of at least one offer (for example four offers in one embodiment of the invention) selected according to the characteristics and tastes of the Internet mobile user;
once selected, the spot is automatically launched in full screen size in the case where it concerns a graphic representation or a video and cannot be viewed in a reduced format;
to make sure that the Internet mobile user is not busy doing something else on his or her computer, a system has been developed. As a matter of fact, to do something else, the Internet mobile user must leave the full screen by pressing a control button on his or her terminal (mobile telephone, PDA, fixed or portable computer). This control means for a fixed or portable computer can be the “escape” key on the keyboard of the computer. By pressing this “escape” key on the keyboard then, the spot as well as the downloading are temporarily stopped. To complete the downloading, the Internet mobile user must then go on viewing the spot in full screen size by resuming the message where the pause started, and
another system makes it possible to guarantee that the Internet mobile user will not leave his or her chair in front of the computer: when the advertisement (or spot) and the downloading are completed, a few seconds' countdown is displayed on his or her screen. To validate the downloading and obtain the final title thereof (audio and/or video file), he or she must click on this countdown. If he or she does not, the title is not obtained and he or she must then review a spot to download it again. Thus, this device makes it possible to prevent an Internet mobile user from launching a spot and immediately leaving his or her computer without viewing it while it is broadcast and while the title is downloaded: as a matter of fact, in such a case, he/she will not be able to click on the countdown and will not obtain his or her title (audio and/or video file).

In addition, the advantage of the invention is that it helps preventing the development of illegal offers for free downloading by not requiring any particular integrated protection or a protection associated with the audio and/or video data transmitted such as DRMs (Digital Right management).

In the prior art, protection types are known of the DRM (Digital Right management) type by Microsoft Windows™. They make it possible to apply a protection limiting the number of transfers of this title onto other computers, portable players (of the MP3 player, telephone, etc. types) and/or to burn it a limited number of times.

Thus, they offer the possibility of protecting audio and/or video data such as files concerning songs in order to prevent their illegal duplication and piracy.

The drawback of this type of protection is that it can be bypassed by software making it possible to ignore and/or eliminate the locks.

Thus, in spite of this DRM, the illegal and free duplication of songs has strongly developed and represents the greatest part of the downloading on the internet, today, which results in the following paradox: the present offer for music is composed of legally, but paying, downloadable songs, with or without the DRM, and illegally and freely downloadable songs, without the DRM.

The invention aims at bringing a solution to this drawback while offering a new alternative: freely and legally downloadable songs with a DRM.

In addition, in the prior art, downloading platforms on the internet are known such as:
legal platform which are paying platforms without advertisement nor distribution of loyalty points convertible into coupons, and
free platforms which are illegal and are not financed by spots nor loyalty points convertible into coupons, either.

These two types of platforms make it possible to obtain music titles without using a physical medium (CD Rom, DVD Rom).

Their drawback is that like the protection by the DRM, the structure and the characteristics of the legal offer incited most of the Internet mobile users to use the second type of offers i.e. the illegal ones.

On the other hand, as regards the broadcasting of spots of the video type on the internet, such spots are most often “pre roll” broadcast, which means prior to the broadcasting of a video content.

The drawback of these prior art embodiments lies in that the spots are not freely selected but imposed upon the launching of the video, that they are not in full screen size by default, and that they have no system making it possible to guarantee that they are really viewed by the Internet mobile user.

The invention makes it possible to correct these various points and thus to strongly increase the value of the advertisements broadcast for the announcers.

In addition, the files in the WMA DRM format (WMA means Windows Media Audio, which is an audio compression proprietary format developed by Microsoft™) does not make it possible to modify the digital information contained in the file to include and automatically modify additional advertisement images on the sleeves of the title.

Thus, a song which is financed by an advertiser (through the purchase of the song as a bonus for one of its products or through a commercial spot bought and broadcast while the song is downloaded) has no mention of this announcer when the downloading is completed.

The invention makes it possible to “customize” with the announcers' marks the music titles proposed and to keep a visual presence of the announcer thereon. As a matter of fact, during the downloading and while a spot is broadcast, the invention makes it possible to automatically modify the downloaded digital file to put, onto the sleeve of the title and onto the name of the file, the mark of the announcer whose commercial spot was chosen by the Internet mobile user.

This invention thus makes it possible to guarantee a continuity of the presence of the announcer's mark on the title for which he made the downloading possible.

In addition, it should be noted that beyond the initial application of this mark, the invention makes it possible, each time the Internet mobile user logs in to this service, to modify if need be the mark applied in order to include a new mark or a new video commercial on the song which will be broadcast when the song is listened to.

The invention participates in an inducement to stop the illegal downloading.

As a matter of fact, the legal and paying platforms offer the Internet mobile users no inducement to stop using the illegal downloading platforms. They only promise that you can obtain a title legally and against compensation.

The invention makes it possible to implement an inducement for the Internet mobile users to quit the free illegal downloading. This problem is solved on the one hand because the title on our platform is free (versus legally downloadable songs but against compensation), and on the other hand through the compensation for the Internet mobile user through loyalty points which can afterwards be converted into coupons to be used with the e-commerce partners of the site.

In addition, the invention also makes it possible to:
download free music files from the internet;
guarantee the viewing of the commercial spot by the Internet mobile user;
modify the audio and/or video data corresponding for example to music files (for example the songs of a music album) so that commercial spots can be included therein, for example onto the sleeves of the albums displayed on the screen of the user's terminal (the Internet mobile user), and
implement a system of compensation/reward through the assignment of loyalty points making it possible to obtain reductions on one's purchases.

### SUMMARY OF THE INVENTION

The present invention aims at solving the problem related to the improvement of information data, for example commercial, in a system for dissemination of digital data.

More specifically, the subject-matter of the invention relates to a method for the dissemination of digital data between a terminal and a digital data dissemination platform including the following steps:
connection of the terminal to a server of the platform,
authentication of a user to his account by the transmission of an identifier to the server,
selection from means of selection of the terminal by user of:
   the digital data to be downloaded, and
   a video spot that the user wishes to see during the downloading of the digital data,
display of the video spot on the screen of the terminal,
wherein the downloaded digital data is validated, in order to be useable, by the user by actuating the means of selection during a time t of a countdown which is displayed on the screen at the end of the broadcasting of the video spot.

According to particular embodiments:
the method comprises the following initial steps
   creation of a user account on the platform, and
   generation of an identifier of the account of which is transmitted to the user;
the step of display comprises an automatic launch of the video spot in full screen size on the screen;
the step of validation generates a credit point stored in the account of the user;
the video spot and the downloading are temporarily stopped if the user leaves the viewing of the video spot in full screen size;
the method comprises a step of modification automatic of the digital data in order to enclose data information relating to the video spot, the data information being displayable on the screen of the terminal during the used of the digital data;
the selection proposed as regards the spots depends on the user's profile stored in the account;
the time t of the countdown lasts a few seconds, and
the method includes the step of using the credit point present on the users' accounts to obtain coupons on the commercial websites which are the platform partners.

The invention is also referred to a system for disseminating digital data for the implementation of the method including a terminal comprising means for the connection with a data distribution platform, said platform including treatment means making it possible to broadcast a spot during the downloading of the digital data.

Advantageously, the terminal is a mobile telephone or a fixed or a portable computer.

In an embodiment, the terminal comprises a screen and means of selection such as keyboard, a mono or multitouch touchscreen, stylus, pointers, mouse, and limited set of keys, handled by one to five fingers.

### BRIEF DESCRIPTION OF THE DRAWINGS

Embodiments of the invention will now be described by way of example only with reference to the accompanying drawings in which:

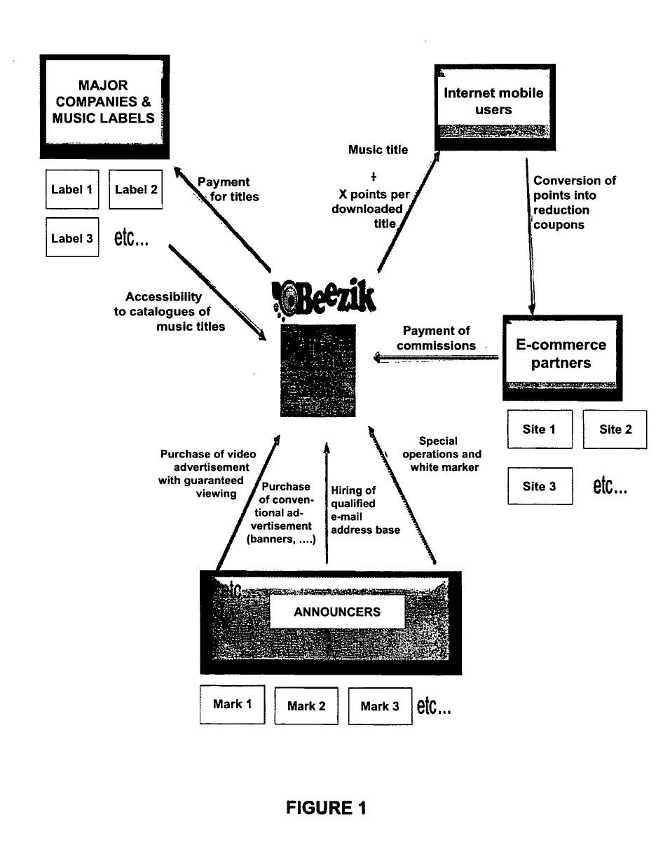

in FIG. 1, a schematic view of the method for distributing audio and/or video data according to the invention;

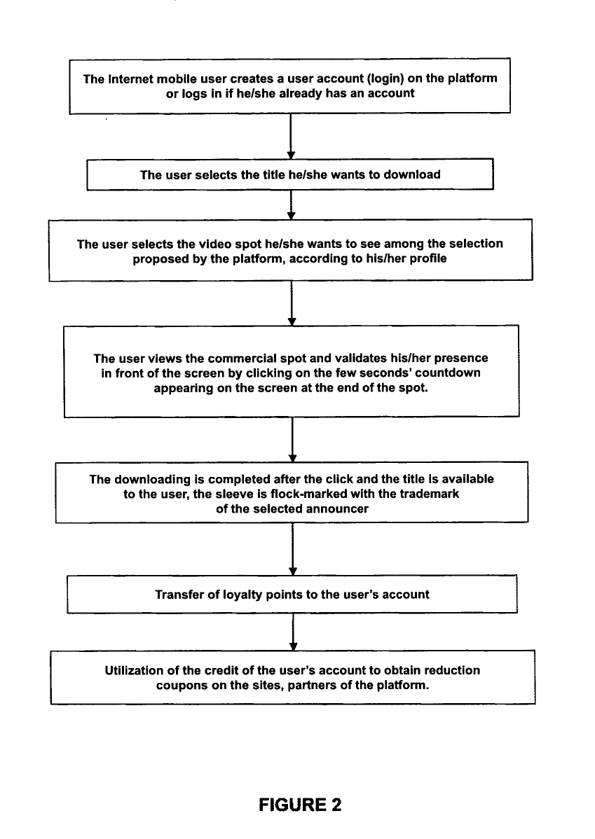

in FIG. 2, a flow chart showing the utilization of the

Beezik distribution platform by the user (client of this platform) according to the invention;

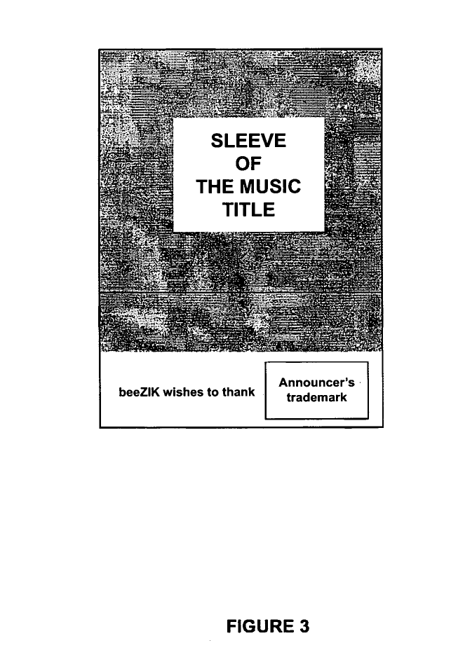

in FIG. 3, a diagram relating to the integration of data information relating rot the video spot (commercial spot) onto the digital data in order to modify the sleeve of the music title;

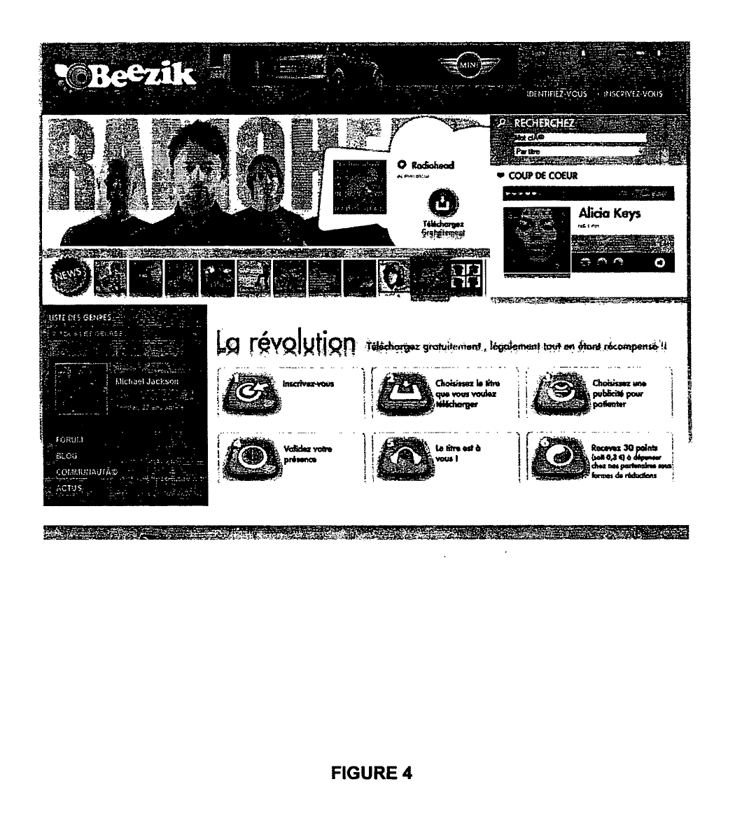

in FIG. 4, a schematic view of the data distribution portal accessible on the internet from the Beezik distribution platform;

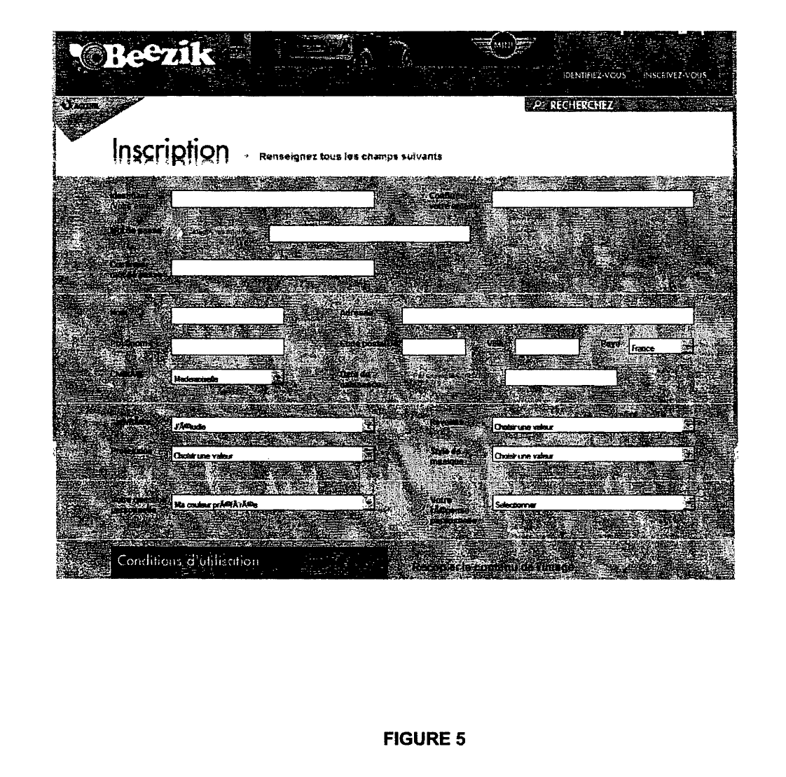

in FIG. 5, a schematic view of the form for the subscription to the portal of the platform;

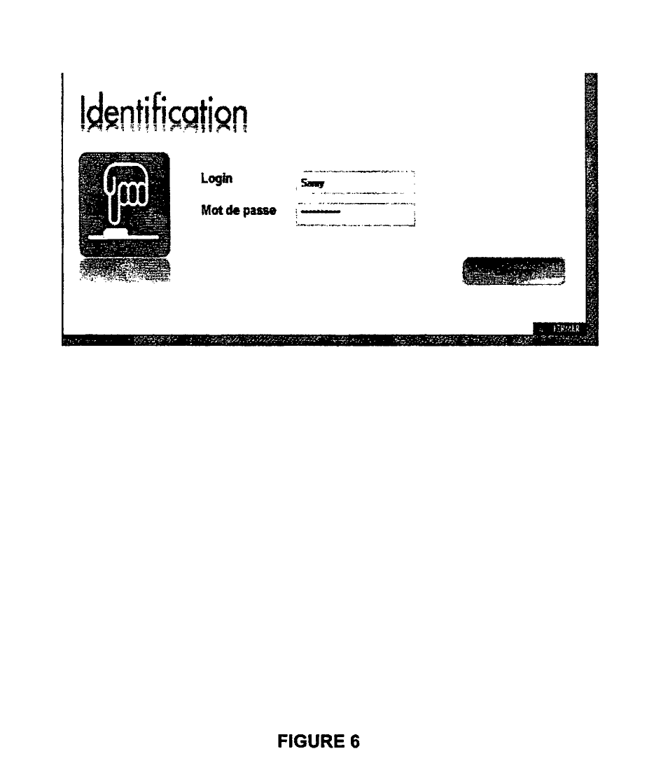

in FIG. 6, a schematic view of the interface for the authentication of the client with the platform;

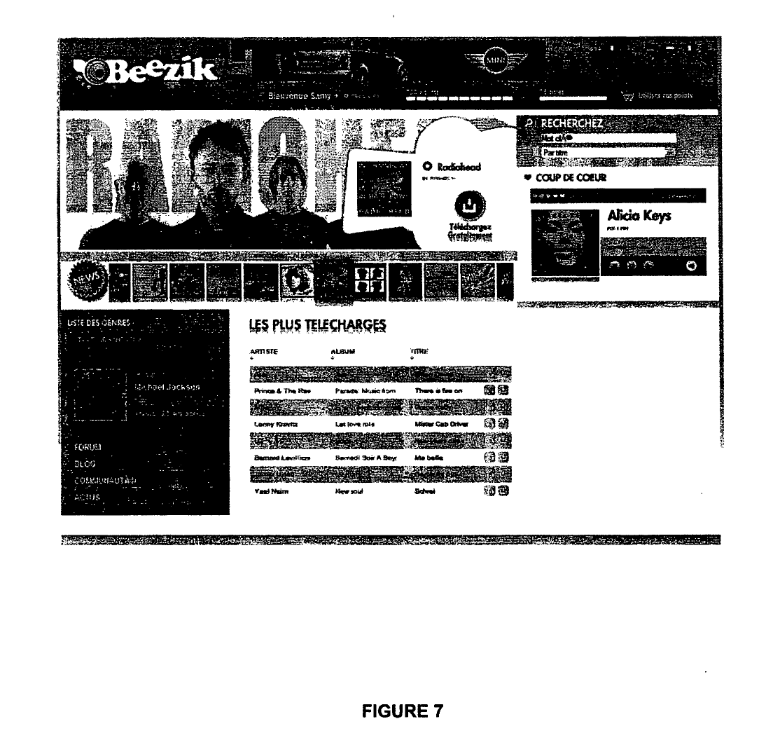

in FIG. 7, a schematic view of the portal interface accessible by the client after the authentication;

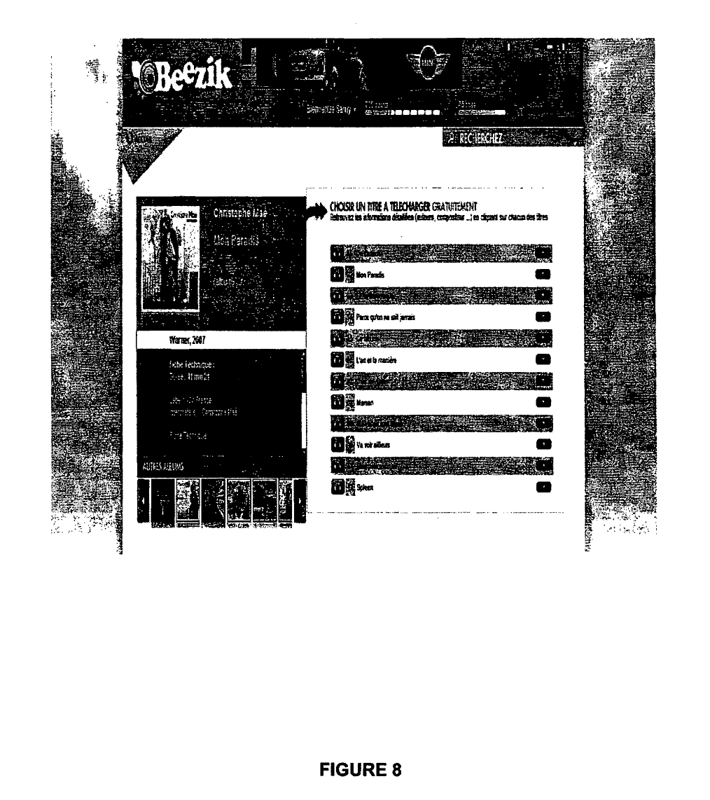

in FIG. 8, a view of a page of the platform website including the titles associated with an album;

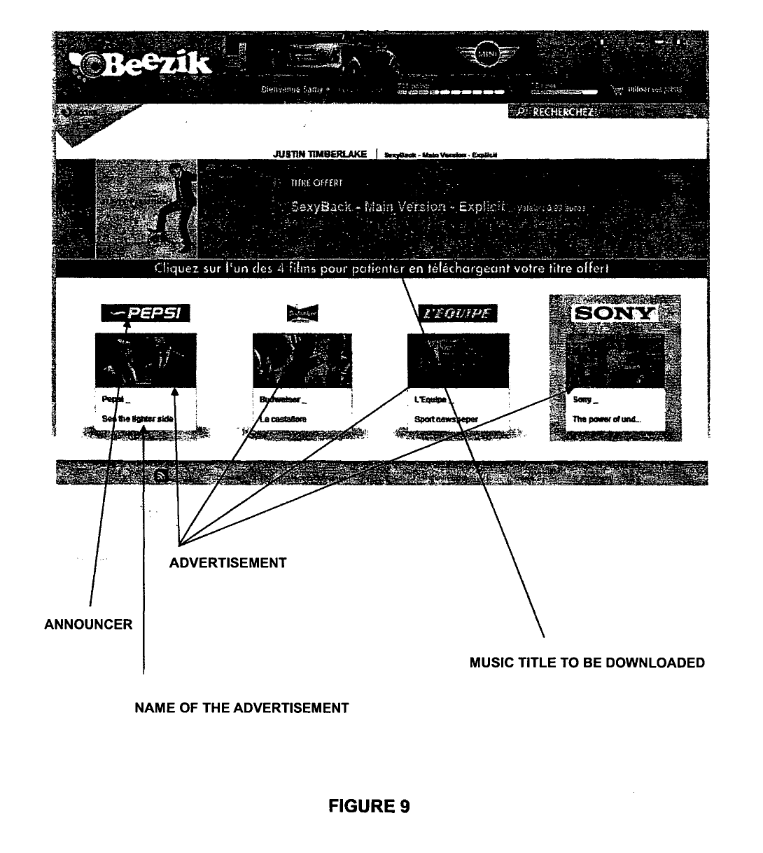

in FIG. 9, a view of a page of the platform website showing a selection of several commercial spots, one of which must be chosen by the client prior to the downloading of a music title;

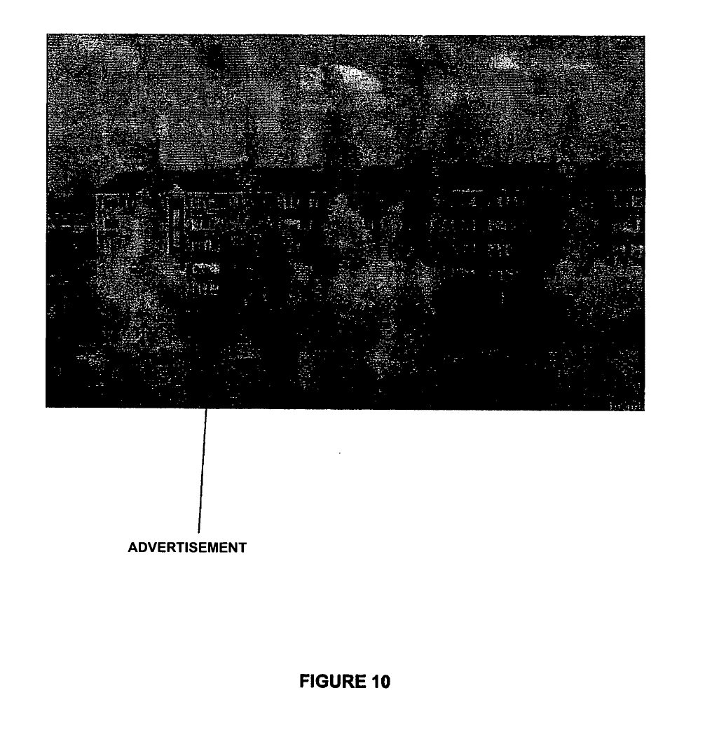

in FIG. 10, a view of a commercial spot type;

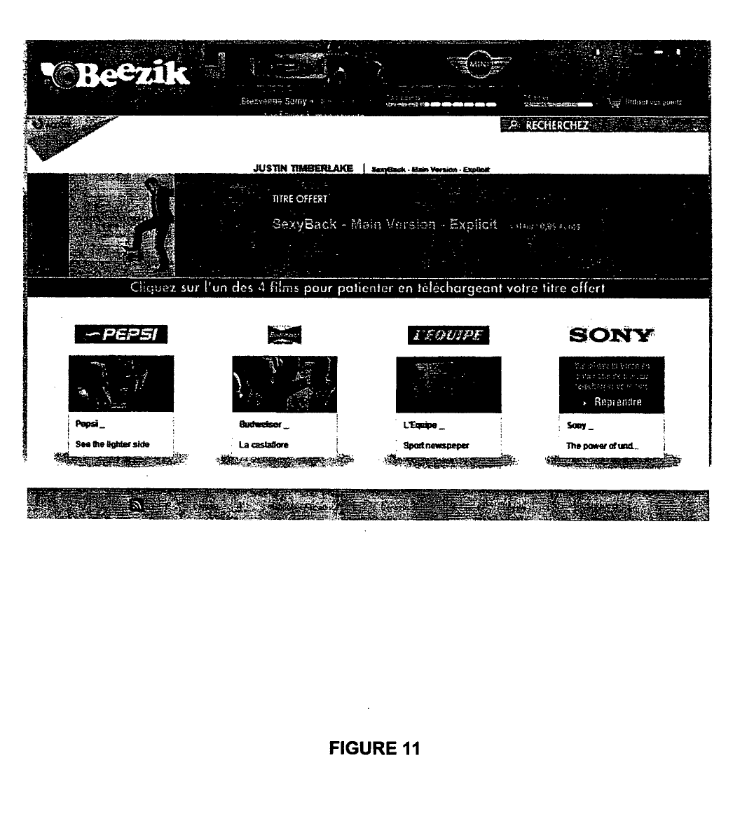

in FIG. 11, a view of the various selections of commercial spots of FIG. 9;

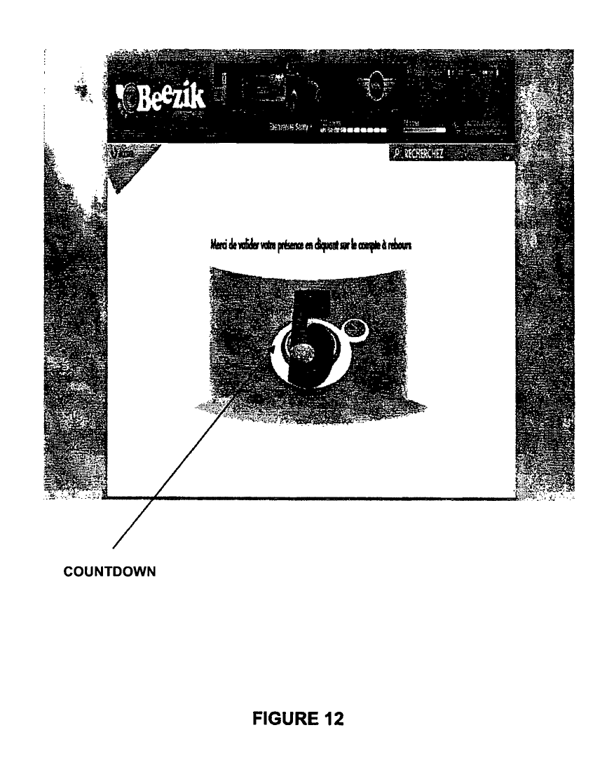

in FIG. 12, a view of a web page displaying the countdown;

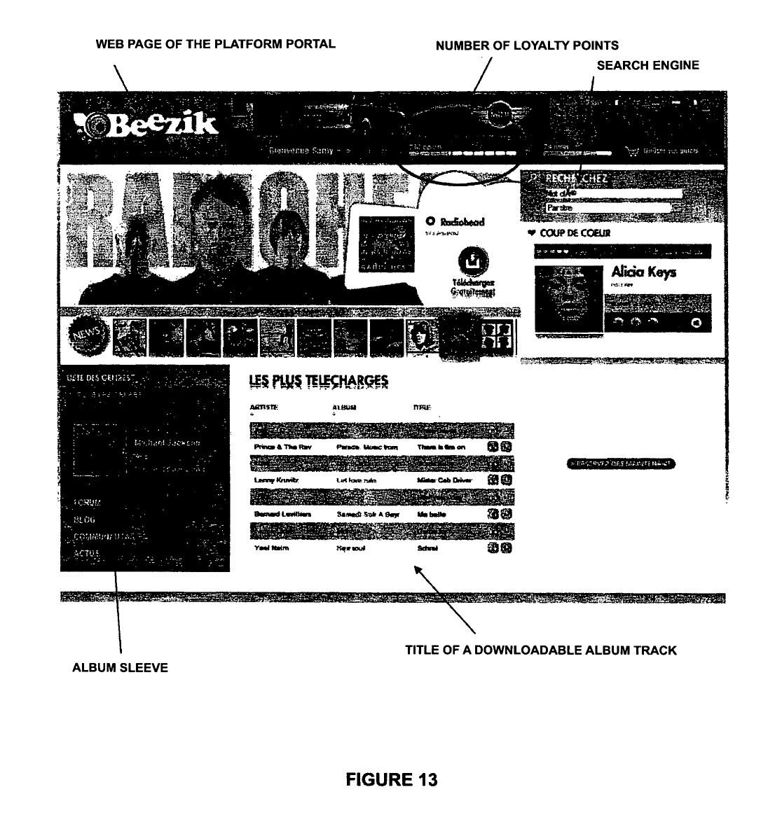

in FIG. 13, a view of a page of the platform website including the number of personal loyalty points on the client's account;

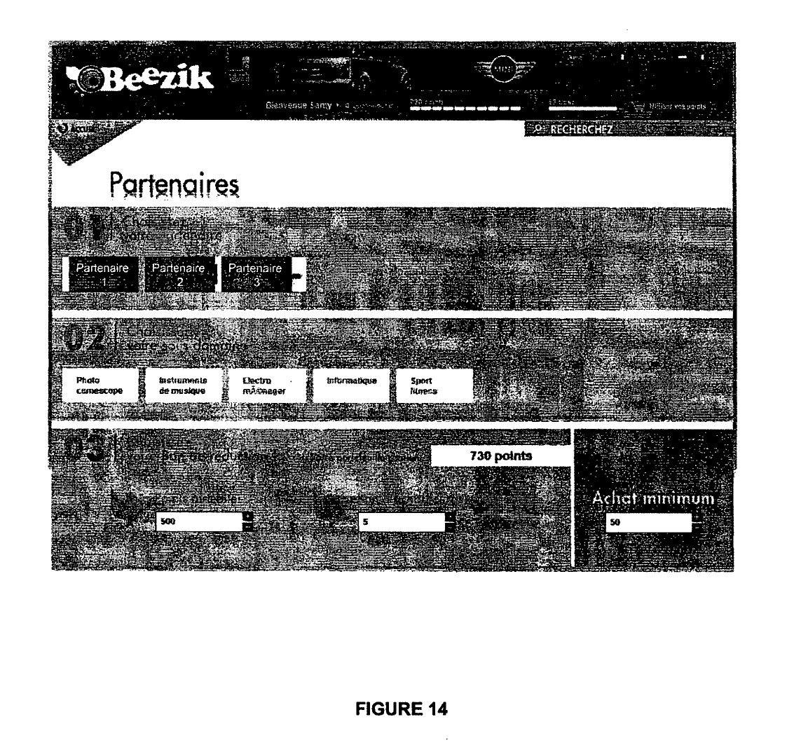

in FIG. 14, a view of a page of the platform website making it possible for the client to use his or her personal loyalty points with a partner of the platform when he or she generates a coupon, and

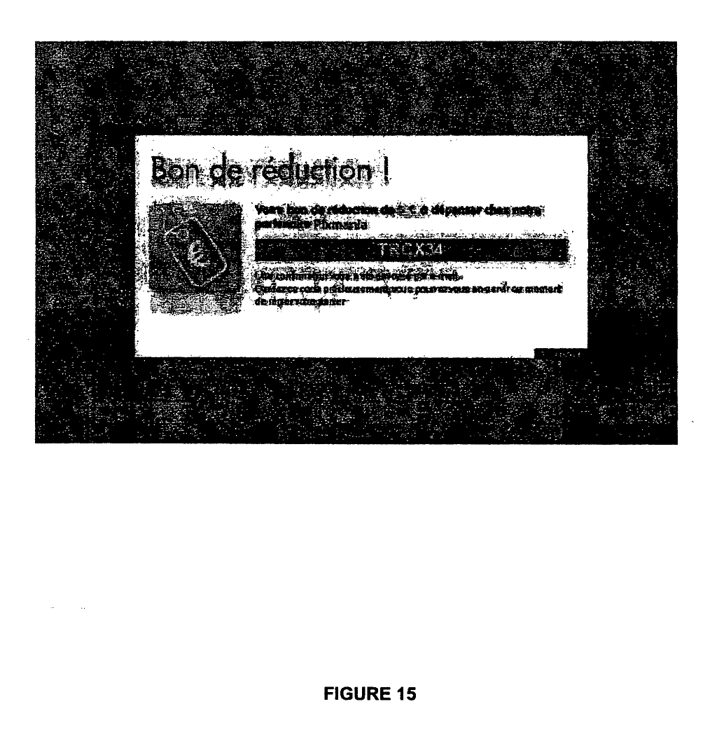

in FIG. 15, a view of another page of the platform website making it possible for the client to use his or her loyalty points on his or her with a partner of the platform.

### DETAILED DESCRIPTION OF THE PREFERRED EMBODIMENTS

Referring now to the drawings, preferred embodiments of the invention are described.

In the FIGS. 1 and 2, the invention makes it possible to associate a commercial spot with a client's (receiving person) profile so as to enable a maximum efficiency during his or her visit of the site and thus be more valuable for the announcers. This is provided in the invention:
by qualifying the Internet mobile users upstream, through a questionnaire upon their subscription to the service and the completion of their profile through subsequent questions, so that this base cannot only be rented but so that commercial spots complying with the tastes of the client can be offered;
by giving the Internet mobile user the choice between several advertisements, as a function of the information on his or her profile, and by letting him or her select the spot he or she wishes to see during the waiting time, during the downloading. Thus, this freely selected spot is much more valuable for the announcer;
by automatically launching the video spot in full screen size to have the greatest possible impact;
by obliging the Internet mobile user to see the whole spot thanks to the device temporarily stopping the commercial spot and the downloading if the Internet mobile user leaves the full screen and/or launches another application on his or her computer, and
by guaranteeing the presence of the Internet mobile user in front of his or her screen during the spot thanks to a countdown at the end of the commercial video which he or she must click on to validate the downloading which imposes him or her to stay in front of his or her screen.

The combination of all these characteristics makes it possible to have a performing and highly valuable commercial device.

The system according to the invention comprises servers connected to database which stores characteristics about the user, collected during his registration and also collected when he his connected to his account by the recording of characteristics relative to his behavior. His account comprises also data relating to credit point.

The system comprises also means of communication for the data exchange between the terminal and the server.

On the other hand, the invention makes it possible to use a downloaded music file as a commercial medium. No site today offers to automatically customize the sleeve of a music title upon the downloading thereof. The invention makes it possible to automatically apply the name of the announcer during the downloading, on the title obtained, further to the viewing of a spot thus giving a perenniality of the announcer's mark on the downloaded medium.

The invention makes it possible to incite the Internet mobile users to use a legal free offer. The only argument of legality is unfortunately not sufficient to convince a part of the Internet mobile users who illegally download files to use a legal, even free offer. One of the principles of the invention is thus to create an incentive thereto by rewarding the Internet mobile user. For this purpose, a system of loyalty points is provided: upon each downloading, the Internet mobile user receives loyalty points. When he or she has accumulated credit points, the Internet mobile user can transform them into reduction coupons which can be used with the e-commerce partners.

The invention provides a diversification of the associated sources of earnings. Beyond the advertisement earnings mentioned hereabove, other sources of financing participate in the viability of the invention:
the constitution and the utilization of a highly qualified database: the subscription to the service is compulsory to use it. Upon this subscription, the Internet mobile user answers various questions making it possible to qualify him or her. During the subsequent utilization of this service, additional questions are regularly asked which make it possible to complete the profile. This base is then marketed;
the marketing in B2B which means with professional and not individual clients. The service with the whole or a part of its characteristics (free and legal downloading for its own clients, videos, assignment of loyalty points which can be transformed into reduction coupons with the e-commerce partners) can be customized as a white marker using the colors and the trademark of a professional client.

In one embodiment, the invention includes:
a legal and free downloading platform on the internet or through a mobile connection, of music titles
making it possible to use a full screen video commercial spot device and guaranteeing the presence of the Internet mobile user in front of his or her screen and his or her viewing the whole of the spot:
the spot and the downloading are temporarily stopped if the Internet mobile user leaves the viewing of the video full screen,
at the end of the spot, a few seconds' countdown is triggered. If the Internet mobile user does not click thereon, the downloading of the title is not validated. This makes it possible to ensure that the Internet mobile user remained in front of his or her screen;
which also makes it possible to automatically modify the data (meta tags) of music files (titles and sleeves) to insert thereon the mark of an announcer whose spot has been viewed as shown in FIG. 3, and
which gives for each downloading a certain number of loyalty points which can then be exchanged against reduction coupons on online commercial sites.

The invention also makes it possible:
to create a performing and innovative commercial device for the announcers;
to incite the Internet mobile users to quit illegal platform and to use this legal service, and
to multiply the financing sources.

Thus, the crossing of the base of data on the Internet mobile users composed upon their subscription, with the displaying modules of the advertisement media (banners, prominent advertisement, videos) making it possible to obtain a very accurate targeting of the broadcast spots.

The title downloading module is associated with the commercial video dissemination module not only to allow the simultaneous execution of both tasks, but also the interruption of the downloading when the Internet mobile users stops viewing the spot by leaving the full screen mode thereof. Leaving the full screen mode using the “escape” function then temporarily stops the broadcasting of the spot as well as the downloading of the music file.

The countdown makes it possible to guarantee that the Internet mobile user remained in front of his or her screen until the end of the broadcasting of the commercial spot has been developed in Flash by the applicant of the present invention. If the countdown is not clicked on, the music file is not accessible.

As regards the flock printing part of the sleeve and the title with the trademark of the selected commercial announcer, the invention provides to compare, in real time, an image i.e. the image bearing the announcer's mark, clicked on by the Internet mobile user, with the WMA file of the title. Technically, this is dynamically executed by online commands through the utilization of a graphic framework of a graphic application. A dynamic photo composition is thus executed between the graphic file of the sleeve of the music file and the image of the announcers' trademark. When this photo composition is carried out, it is inserted in real time and during the downloading of the title into the media (i.e. WMA for V1.0) at the same time as the other meta-data (title, author, etc.).

Finally, the invention makes it possible to combine a module attributing loyalty points with the final validation of the downloading by the clicking on the countdown as mentioned hereinunder.

Other advantages provided by the invention are as follows:
it makes it possible to obtain freely and legally for the Internet mobile user the music title he or she wishes while being rewarded by the assignment of loyalty points convertible into reduction coupons which can be used on e-commerce sites, and
by letting him or her freely select a video spot among 4 spots targeted according to his or her characteristics, the invention takes into account the Internet mobile users' tastes and desires instead of unilaterally imposing him or her a non desired spot which does not potentially correspond to his or her expectations.

As regards commercial announcers, the advantages are as follows:
as the spot is targeted on criteria on the one hand and as it is selected by the Internet mobile user himself or herself to be viewed, it has a much higher impact and memorization rate than the existing online advertisement systems;
thanks to the device temporarily stopping the spot in case the Internet mobile user stops viewing the full screen video on the one hand and on the other hand to the validation of the presence of the Internet mobile user in front of the screen through the countdown at the end of the broadcasting of the video, the announcer is sure that his spot has been viewed until the end,
the flock-marking with the announcer's trademark on the sleeve of the downloaded title makes it possible for the latter to have a continuous presence of his mark with the Internet mobile user since he or she will be reminded thereof each time he or she listens to this title.

As regards the persons having an interest on music rights, (author, composer, record company):
Associating a reward to the legal and free downloading is an innovative technical and marketing device which can induce the Internet mobile user to stop using the illegal downloading platforms.

In operation, the invention provides for:

A—Information Typology:

A SGBD/R (Relational data base management system) makes it possible to manage the whole information in the Beezik system (Audio and/or video data broadcasting platform). This makes it possible to guarantee the relational integrity and the consistency of the data on the whole system.

Operational information are kept, which makes it possible to meet the reporting and driving needs of the global activity of the system.

Four main types of meta-data are to be considered:

1—All the information relating to the subscribing Internet mobile user

2—All the information relating to the advertising campaigns and to the announcers,

3—All the information relating to the majors and music labels available online,

4—All the information relating to the E-commerce partners and the associated products.

These four main data assemblies are organized as a function of:

1—the selections by the Internet mobile user and his or her profile (musical preferences), age, etc

2—the targeting of the advertising campaigns as a function of discriminating criteria

3—music typologies and songs proposed by the most often downloaded major companies

4—the categorization of the partners and the products they offer (reduction coupons)

Then the data system makes it possible to restore and to trace over time:
all the Internet mobile users (together with the details thereon) having downloaded music files (with the details on the songs and their related information: music typology, albums/titles, associated major),
all the data relating to the announcers and the commercial campaigns viewed associated to the legal downloading of offered music titles,
all the E-commerce partners and their associated products participating in this dynamics with the loyalty points distributed and the reduction coupons which can be obtained therefrom.

B—Iterative Qualification of the Operational System

The targeting of the Internet mobile user's profile is refined as a function of the number of files he or she legally downloads. As a matter of fact, for each downloaded file, he or she must select a video to be viewed. In addition, loyalty points are accumulated on his or her account and the utilization thereof makes it possible to target his or her favorite E-commerce partners. This iterative loop makes it possible to qualify the users' profiles over time in order to propose more and more relevant selections, thus ensuring the development of customer loyalty to the service and a progressive increase in Beezik's visibility.

In addition, the driving of the campaigns, announcers and E-commerce partners based on the historical information makes it possible to draw statistics and to highlight indicators in order to adapt the choices as a function of the identified modifications in their tastes and the current fashion trends.

C—Execution of the General Functional Algorithm

The operation of the service is mainly based on the simplicity of the concept and path to follow. This simplicity is, in fact, the best guarantee of the correct understanding by the Internet mobile user of the offer, his or her subscription to the service and the regular renewal of his or her utilization thereof.

First, the Internet mobile user must connect to the internet site whereon the service is delivered:

a) Preamble: the Subscription to the Service To have access to the downloading of WMA format files, the Internet mobile users must previously subscribe and give some information on their profile (age, sex, domicile, tastes). They are prompted to answer the questions honestly by being informed that this will make it possible to offer, on the site, spots corresponding to their tastes.

When they have subscribed, the Internet mobile users identify themselves to have access to all the functionalities of the site.

Then they have access to the page reserved to subscribers to the service.

He or she can look for the title he or she wants to download either by consulting the albums (by genre or artist) or making a request through a search engine. When he or she has access to the artist's page with the single he or she wants, he or she can directly consult other albums or titles by the same artist, listen to extracts of various titles to validate his or her selection or simply listen to new releases if he/she so wishes.

b) A Full Screen Video Commercial Spot for Each Downloaded Title

When he or she wants to download a title, the Internet mobile user clicks thereon. Then he/she is informed that the title, which costs X [symbol] will be paid for by an announcer. Four various commercial spots targeted according to his or her tastes and his or her personal situation are proposed to him or her.

The commercial spots have been created in a separate module. For each of them, an intuitive interface for non-specialists makes it possible to mention, for each of the fields of the user's profile, the selected or excluded values, like for example age>30 which means that only users over 30 will be targeted.

The 4 commercials proposed then are 4 commercials among those which are targeted by the connected user. He will not be informed of the other commercial spots. Technically, the targeting is in fact a simple request by SQL on a SGBD. The profile is stored in an SQL table.

The targeting is the dynamic construction of a request SQL of the WHERE type, from the association of a clause graphically defined. This is a simple assistance to inputting for the persons who do not know SQL or the structure of the underlying tables.

By clicking on one of the labels, he or she then launches a commercial video in full screen size. The video lasts between 10 and 30 seconds, and can be “clicked on” to have access to the announcer's site. The single downloading bar is in addition visible on the screen during the broadcasting of the commercial: this commercial is thus not a “waste of time”.

If the Internet mobile user leaves the commercial spot to launch another task on his or her computer, the spot and the downloading are interrupted. He will or she will then have to resume the viewing of the commercial to complete the downloading of the song.

This is a system making it possible to stop the downloading and the commercial when the full screen is left using the escape key.

The function provided when using the “escape” key belongs to the Adobe Flash full screen mode. The added advantage consists in listening to the player condition (full screen/normal mode).

For each respective case, the procedure is resumed or stopped.

Upon completion of the downloading, the Internet mobile user must click within the few following seconds on a validation button to finally validate the downloading. This system thus makes it possible to guarantee the viewing, contrary to many other online commercial formats.

This is a technical mode of implementing the downloading which makes it possible, depending on whether the Internet mobile user clicked thereon or not, to deliver or not the audio file that the Internet mobile user selected for downloading.

When the counter appears, the countdown is launched from a random integer (between 1 and 10) supplied to the flash. Beyond this countdown, the downloading is no longer possible and the user is sent back to the page offering the commercial spots with a warning message.

During the countdown, the user can click anywhere on the flash and validate his or her downloading. The downloading consists in launching a “download” from the flash (he or she downloads the file created *). The file is preloaded during the playing of the video. If the preloading is completed prior to the end of the video, the video must be completed first.

“Pre-downloading” means a previous copy on the hard disk of the client (compulsory). This temporary file which is not named mp3 or has no intelligible name is thus placed into the user's buffer memory (with respect to the web navigator he or she uses).

When the commercial is launched, a script (called by flash) is executed on the server side. This script uses as a parameter the user session and the identification of the song and will rewrite the mp3 file and integrate therein the name of the partner sponsorizing this downloading.

Thus, if the user downloads a song while viewing the xyz commercial, the mp3 will contain an xyz image in its tags. The mp3 format file will then be named “xxx-xxx-courtesy of xyz.mp3”.

c. The Title Sleeve Marked with the Announcer's Trademark

With the digital file of the song, the Internet mobile user also downloads the sleeve of the single. Another specificity of Beezik is that the name of the file as well as the sleeve of the song bear the words “courtesy of”, followed by the announcer's trademark on the commercial of which the Internet mobile user clicked to be able to download the file.

This flock-marking, which is not a problem for the Internet mobile user, with respect to the advantage of having the sleeve of the title, guarantees for the announcer a continuity of the presence of the mark close to the contact, as well as the “present” given.

The flock-marking procedure is as follows.

A jpeg format image file which is a true representation of the album sleeve is associated with each of the titles of an album.

Upon the downloading of a song, a new image still in the jpeg format is created from the image of the album sleeve and the image file of the announcer's trademark.

This new image re-created from the album's photographs and the announcer's trademark bearing the embedded mention “Beezik wishes to thank” which belongs to the image is associated with the downloaded song and will be displayed on all the players (QMP, Itunes) whenever the song is listened to.

The re-creation of the sleeve is carried out when the downloading of the song is validated.

d. A Song Available to any Type of Equipment

The thus downloaded song has a “portability” so that it can be listened to anywhere: it can be transferred onto two computers, up to 5 terminals (MP3 players, multimedia mobile telephones), and burnt up to 7 times on a CD, for example to be listened to in a car.

e. A Reward for the Internet Mobile User for Each Legal Downloading on Beezik

Beezik imagined a system of rewards for inducing the Internet mobile user to use this legal offer. Thus, the Internet mobile user cannot only freely download singles among the market catalogues, but in addition it is rewarded therefore.

For each downloading, his or her personal credit increases by a lump amount per title (X euro cents) to be spent exclusively with Beezik partners.

His/her current account increases upon each downloading and he or she can decide to use them at any time for buying goods or a service with one of Beezik E-commerce partners.

He or she will then convert the number of points he or she wishes to use into a reduction on his or her purchase, the latter being however limited to a maximum percentage of the total invoice which can vary depending on the partners.

This advantage for the Internet mobile users makes it possible to make the offer more attractive than the illegal downloading and is a strong differentiation factor with respect to the competitors if any. Variances can be provided with respect to the invention.

First, the video commercial format with one or both techniques (pausing in case the full screen video is abandoned and the countdown system), for the validation of the presence of the Internet mobile user can be applied to many other cases: it can be applied to the downloading of any type of content beyond music: other sound formats (radio program, interview), video formats (music clips, films, TV programs, series, video entertainments, personal videos), alphabetic formats (editorials, press, press releases, books), or code formats (computer programs, shareware, freeware).

Another variant can be the integration of another graphic or video or text into a downloaded file: for example, a short video commercial could be integrated into a downloaded film file (this commercial spot being played and broadcast upon the launching of the film) or integrated into a downloaded press article or a graphic commercial space. Of course, this alternative solution can be combined with the previous one.

A third alternative provided by the invention consists in subsequently and regularly modifying the graphic or video or text files downloaded to modify the characteristics thereof and retrieve information: thus, within the scope of music songs for example, it will be possible, upon each connection to the site, to change the trademark or the message from the announcer mentioned on the sleeve of the downloaded music file. Simultaneously, information relating to the number of utilizations of this file will be sent back to the site database. This will make it possible to transform this music files into real commercial medium which can be marketed with announcers, well beyond the moment when they were downloaded: as long as the file is played, a commercial can be broadcast.

The invention is not limited to the exemplary embodiments described and illustrated. Furthermore, it is not limited to the exemplary embodiments nor to the described alternative solutions.

It should be noted that the invention makes it possible to offer services by modifying the characteristics such as:
a video commercial in a non full screen format (example: ½ screen, ¾ of a screen etc. instead of the full screen);
a non video commercial (sound, still picture, animated gif banner);
no system for pausing the downloading in case the full screen is left or if another job is started on the computer;
no countdown at the end of the downloading or substitution of a question;
no selection provided between 4 commercials for the Internet mobile user but the selection between 2, 3 or even no selection at all;
no flock-marking of the title with the announcer's trademark or a flock-marking in a slightly different format (other graphic format, video format);
no system giving loyalty points upon each downloading;
no system making it possible to spend these loyalty points with third party sites;
a different DRM protection or no DRM;
a similar proposition but founded on streaming;
application of the invention, as a whole or partially to other contents than music: downloading of V.O.D, editorials, etc.

The method and system for the dissemination digital data is only an example of suitable mechanism for the dissemination and is not intended to suggest any limitation as to the scope of use or functionality of the invention. Neither should be interpreted as having any dependency or requirement relating to any combination of components illustrated in the exemplary mechanism for the dissemination of digital data.

1. A method for the dissemination of digital data between a terminal and a digital data dissemination platform including the following steps:
connection of the terminal to a server of the platform,
selection from selection means of the terminal by user of the digital data to be downloaded, and
download of said digital data, and
play an advertising content in the terminal,
wherein the final useable digital data is obtained by the user by actuating the selection means during a time t at the end of the playing step.

2.-12. (canceled)

13. A method according to claim 1, wherein said time t is a countdown time.

14. A method according to claim 1, wherein said time t is a time for answering a question displayed.

15. A method according to claim 1, wherein said advertising content is selected from the group comprising a video sequence, a sound sequence, a still picture, an animated picture.

16. A method according to claim 1, further comprising, before the step of playing the advertising content, a step of selecting an advertising content that the user wishes to perceive.

17. A method according to claim 16, wherein said step of selecting and advertising contents comprises a selection among a plurality of advertising contents.

18. A method according to claim 17, wherein said plurality of proposed advertising contents depend on a user's profile.

19. A method according to claim 18, wherein said user's profile is determined from an identifier of a user's account for connecting to the server.

20. A method according to claim 1, wherein said advertising content is selected from a video, a still image and an animated image, and said step of playing the advertising content comprised displaying the content is full screen mode.

21. A method according to claim 20, wherein the displaying step is automatically launched.

22. A method according to claim 20, comprising the step of interrupting the playing step, and the downloading step if in progress, when leaving the full screen mode visualization.

23. A method according to claim 19, further comprising the step of generating credit points on the user's account when the final useable digital data had been obtained.

24. A method according to claim 1, further comprising a step of automatically modifying the digital data in order to enclose data information relating to the advertising content, wherein said data information can be displayed on a screen of the terminal.

25. New A system for disseminating digital data for the implementation of the method according to any preceding claim, including a terminal comprising means for the connection with a data distribution platform, said platform including processing means capable of transmitting advertising content data and the digital data to the terminal.

26. A system according to claim 25, wherein the terminal comprises a screen and the selection means are selected from a group comprising keyboards, a mono- and muititouch touchscreens, stylus, pointers, mice, and limited sets of keys.

27. A method according to claim 13, wherein said advertising content is selected from the group comprising a video sequence, a sound sequence, a still picture, an animated picture.

28. A method according to claim 14, wherein said advertising content is selected from the group comprising a video sequence, a sound sequence, a still picture, an animated picture.

29. A method according to claim 21, comprising the step of interrupting the playing step, and the downloading step if in progress, when leaving the full screen mode visualization.
